(19) United States
(12) Patent Application Publication
(10) Pub. No.: US 2007/0070827 A1
(43) Pub. Date: Mar. 29, 2007

(54) Record carrier, device and method of scanning the record carrier

(75) Inventor: Hubert Cecile Francois Martens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/574,149

(22) PCT Filed: Sep. 28, 2004
(86) PCT No.: PCT/IB04/51892

§ 371 Date: Mar. 29, 2006

(30) Foreign Application Priority Data
Oct. 3, 2003 (EP) 03103673.4

(51) Int. Cl. G11B 21/08

(52) U.S. Cl. 369/30.12

(57) ABSTRACT

A device for recording information writes and reads marks and spaces which each have a nominal run length. The power of a radiation source is controlled for writing the marks and spaces in accordance with a power pattern in dependence on the run length. The power pattern for a mark of a long run length comprises at least three pulses having a write power (65), at least one first intermediate period between the pulses having a bias power (66), and at least one second intermediate period between the pulses having a reduced bias power (70), the at least one second intermediate period including the intermediate period before the final pulse of the power pattern. Due to the reduced bias power, the preheat at the start of a next mark after a long mark and a space is reduced.

The invention relates to a device for recording information in a track on a record carrier, the device comprising a head for generating a beam of radiation from a radiation source for writing marks and spaces between the marks, the marks and spaces each having a nominal run length of a predetermined number of bits, and the marks having a multitude of different run lengths for representing the information, the different run lengths being within a range of run lengths and the range including at least one short run length and at least one long run length that is longer than the short run length.

The invention further relates to a method of controlling the power of a radiation source during recording of information in a track on a record carrier, the method comprising the writing of marks and spaces between the marks, the marks and spaces each having a nominal run length of a predetermined number of bits, and the marks having a multitude of different run lengths for representing the information, the different run lengths being within a range of run lengths and the range including at least one short run length and at least one long run length that is longer than the short run length.

The invention further relates to a record carrier of a recordable type.

A method and apparatus for recording information on a record carrier are known from WO01/86643. The record carrier is of a recordable type and has a track for recording information, e.g. a spiraling on a disc-shaped carrier indicated by a wobbled pregroove. The device comprises a drive unit for rotating the record carrier. For scanning the track, an optical head is positioned opposite the track by a positioning unit, while the record carrier is rotated. The head has a laser and optical elements for generating a beam of radiation for writing marks and intermediate spaces. The length of a mark or space has a nominal value of a predetermined number of units of length, usually called “run length” and measured in bits, and the marks and spaces constitute a recorded pattern for digitally representing the information in accordance with a modulation code. The device has a control unit for controlling the laser power to a desired value during writing. The power for a mark is controlled in dependence on the length of the mark. It is noted that the conditions at the beginning of a mark are different due to preheating caused by writing of the preceding mark. In particular the power at the beginning of a mark is made dependent on the length of the preceding space to compensate for the preheat. A problem is that the lengths of the marks and spaces deviate from the expected values.

It is an object of the invention to provide a recording device and corresponding method for achieving marks and spaces that correspond to the desired lengths.

For this purpose, the device as described in the opening paragraph has radiation source control means for controlling the power of the radiation source during said writing in accordance with a power pattern in dependence on the run length, the power pattern for a mark of the long run length comprising at least three pulses having a write power, at least one first intermediate period between the pulses having a bias power, and at least one second intermediate period between the pulses having a reduced bias power, the at least one second intermediate period including the intermediate period before the final pulse of the power pattern.

The method as described in the opening paragraph comprises controlling the power of the radiation source during said writing in accordance with a power pattern in dependence on the run length, the power pattern for a mark of the long run length comprising at least three pulses having a write power, at least one first intermediate period between these pulses having a bias power, and at least one second intermediate period between these pulses having a reduced bias power, the at least one second intermediate period including the intermediate period before the final pulse of the power pattern.

The effect of the measures is that the total energy applied for writing the long mark is reduced while forming the final part of the long mark. It is to be noted that due to the power pattern of pulses having the write power, the final part of the mark is formed substantially having a nominally required size. However, said reduced total energy reduces the preheat at the beginning of a next mark after the long mark in comparison with writing a long mark with a power pattern without reduction of the bias power.

The invention is based on the following recognition. Measurements of deviations of the marks, such as jitter measurements, are used to detect the quality of the recorded marks and spaces. Although the document WO01/86643 describes a method of compensating the effect of preheat in dependence on the length of the preceding space, jitter measurements showed unsatisfactory results surprisingly even with a single length of the space. The inventors have seen that different lengths of the preceding mark result in different amounts of preheat, which result in increased jitter values. The preheat is caused by energy transferred from the final part of a mark via the adjacent space to the area of the beginning of the next mark. Secondly, the inventors have seen that the total amount of energy at the final part of longer marks can be reduced without substantially affecting the size of that longer mark. The reduced total energy in the final part of the longer marks reduces the difference in preheat caused by short marks and long marks.

In an embodiment of the device, the reduced bias power is gradually reduced in dependence on the run length, or the reduced bias power comprises at least two reduced bias power levels. The effect of additionally controlling the amount of reduction of the bias power is that a further adjustment of the energy reduction during longer marks is made possible. This has the advantage that the preheat differences for different lengths of longer marks are reduced.

In an embodiment of the device, the reduced bias power is applied from a predetermined moment with respect to the start or the end of the power pattern. This has the advantage that a simple control mechanism for the amount of bias power is used. Moreover, the bias power can also be reduced during an intermediate period.

In an embodiment of the device, the long run length is substantially twice the minimum run length in the range of run lengths. The greatest differences have been found between marks of up to about twice the size of the shortest mark in practical embodiments. Hence this has the advantage that the greatest differences are compensated.

According to a further aspect of the invention, the record carrier as described in the opening paragraph is designed for recording information by the method described above, the record carrier comprising control information for setting the reduced bias power. This has the advantage that the power of the radiation source in the power pattern can be adjusted by the manufacturer of the record carrier in that specific parameters relating to the reduced bias power are included.

Further advantageous embodiments are given in the dependent claims.

These and other aspects of the invention will be apparent from and elucidated further with reference to the embodiments described by way of example in the following description and with reference to the accompanying drawings, in which

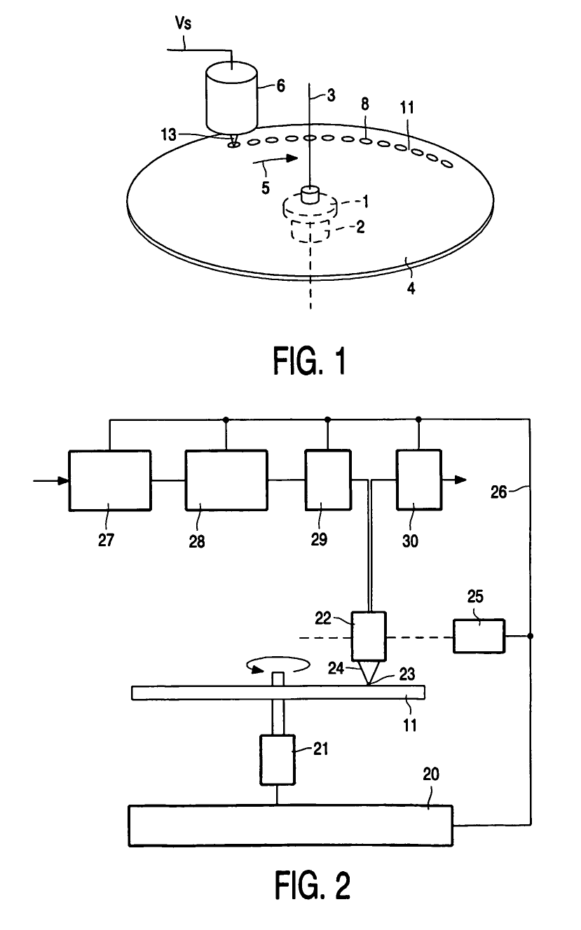

FIG. 1 schematically shows the recording process on an optical record carrier,

FIG. 2 shows a recording device,

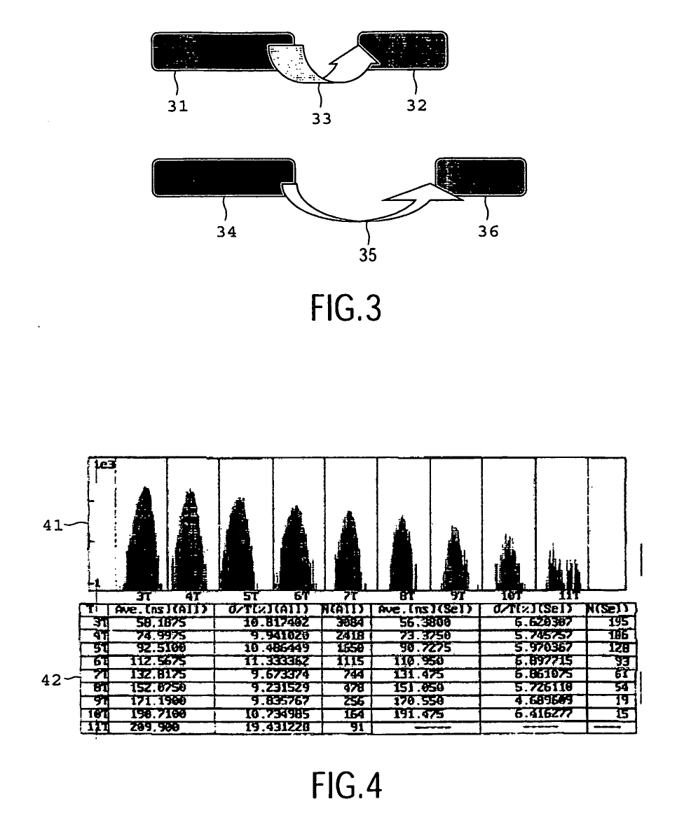

FIG. 3 shows preheating due to a preceding mark,

FIG. 4 shows a graph of inter-symbol interference,

FIG. 5 shows accumulation of heat and resulting preheat,

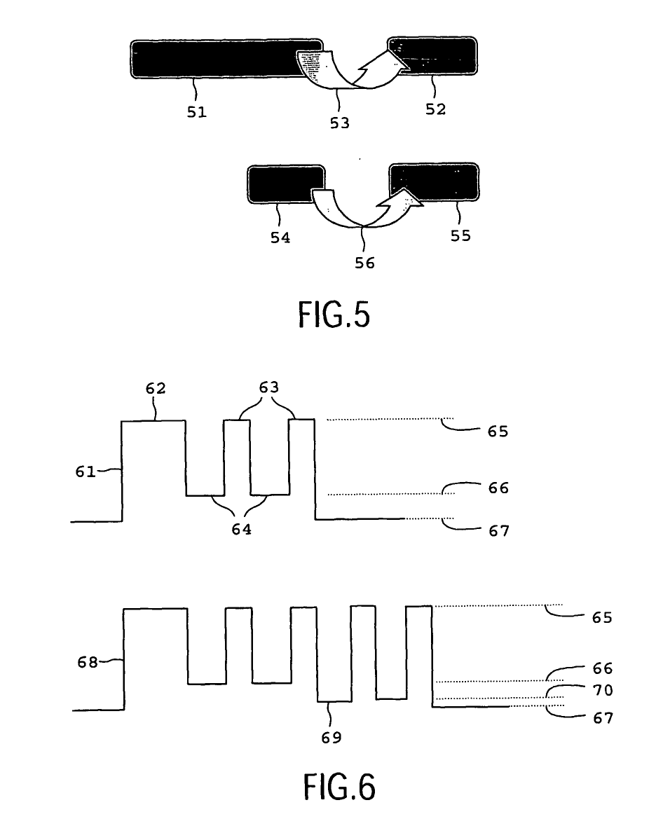

FIG. 6 shows write power patterns having reduced bias power in longer marks,

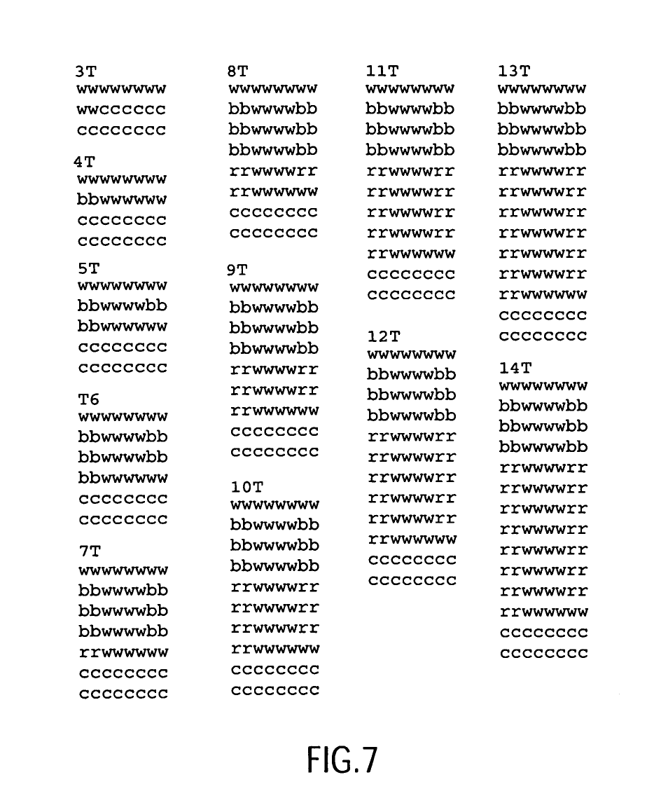

FIG. 7 is a representation of power patterns for a range of run lengths, and

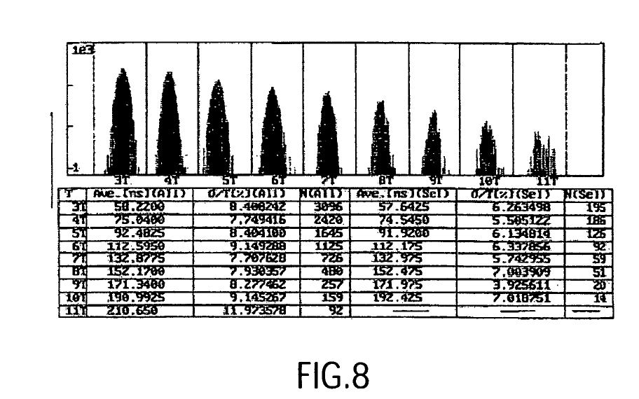

FIG. 8 shows a graph of inter-symbol interference using the power patterns having reduced bias power.

Corresponding elements in different Figures have identical reference numerals.

FIG. 1 schematically shows the recording process on an optical record carrier. A recording device comprises a turntable 1 and a drive motor 2 for rotating a disc-shaped record carrier 4 about an axis 3 in a direction indicated by an arrow 5. The record carrier has a track 11 for recording marks 8, the track being located by a servo pattern for generating servo tracking signals for positioning an optical head opposite the track. The servo pattern may be, for example, a shallow wobbled groove, usually called a pre-groove, and/or a pattern of indentations, usually called pre-pits or servo pits. The record carrier 4 comprises a radiation-sensitive recording layer which upon exposure to radiation of sufficiently high intensity is subjected to an optically detectable change such as, for example, a change in reflectivity for forming marks 8 and intermediate spaces constituting a recorded pattern representing information. Each element in the pattern has a nominal run length expressed in units called bits. The run lengths represent the information in accordance with a modulation scheme usually called channel code.

The radiation-sensitive layer may comprise, for example, a thin metal layer which can be removed locally by exposure to a laser beam of comparatively high intensity. Alternatively, the recording layer may consist of some other material such as a radiation-sensitive dye or a phase-change material, whose structure can be changed from amorphous to crystalline or vice versa under the influence of radiation. The marks may be in any optically readable form, e.g. in the form of areas with a reflection coefficient different from their surroundings obtained during recording in materials such as dye, alloy or phase-change material, or in the form of areas with a direction of magnetization different from their surroundings obtained during recording in magneto-optical material.

An optical write head 6 is arranged opposite the track of the (rotating) record carrier. The optical write head 6 comprises a radiation source, for example a solid-state laser, for generating a write beam 13. Controlling the write power for creating a mark is adapted to the pattern of marks that has to be recorded, which is called a write strategy. In high-density recording sophisticated write strategies are implemented, e.g. controlling of the write power in dependence on the length of the mark to be written and/or the size of the preceding space. The parameters in the write strategy that determine the write power in dependence on time and the mark to be recorded are called a power pattern of the write strategy.

For writing, the intensity of the write beam 13 is modulated by a control signal Vs in accordance with the power pattern. The intensity of the write beam 13 in the power pattern for recordable discs varies between a write power which is adequate to bring about detectable changes in the optical properties of the radiation-sensitive record carrier for forming a mark and a low (or zero) cooling power which does not bring about any detectable changes, for creating an intermediate area in between every two marks, further called space. The power for a space on a rewritable disc is chosen such that it erases any previously recorded marks; it is called an erase power.

For reading, the recording layer is scanned with a beam 13 whose intensity is at a reading level of a constant intensity which is low enough to preclude any detectable change in optical properties. The read beam reflected from the record carrier during scanning is modulated in conformity with the information pattern being scanned. The modulation of the read beam can be detected in a customary manner by means of a radiation-sensitive detector which generates a read signal which is indicative of the beam modulation.

FIG. 2 shows a recording device for writing and/or reading information on a record carrier 4 of a type which is writable or re-writable, for example CD-R or CD-RW, or a recordable DVD. The device is provided with scanning means for scanning the track on the record carrier, which means include a drive unit 21 for rotating the record carrier 4, a head 22, a positioning unit 25 for coarsely positioning the head in the radial direction on the track, and a control unit 20. The head comprises a radiation source, e.g. a laser diode, an optical system, and additional circuitry of a known type for generating a radiation beam 24. The radiation beam is guided through optical elements and focused into a radiation spot 23 on a track of the information layer of the record carrier. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information, the radiation is controlled so as to create optically detectable marks in the recording layer. For reading, the radiation reflected by the information layer is detected by a detector of a usual type, e.g. a four-quadrant diode, in the optical head for generating a read signal and further detector signals including a tracking error and a focusing error signal for controlling said tracking and focusing actuators. The read signal is processed by a read processing unit 30 of a usual type including a demodulator, deformatter, and output unit to retrieve the information. Hence retrieving means for reading information include the drive unit 21, the optical head, the positioning unit 25, and the read processing unit 30. The device comprises write processing means for processing the input information so as to generate a write signal to drive the optical head, which means comprise an input unit 27, a formatter 28, and a laser power unit 29. The control unit 20 controls the recording and retrieving of information and may be arranged for receiving commands from a user or from a host computer. The control unit 20 is connected via control lines 26, e.g. a system bus, to said input unit 27, formatter 28 and laser power unit 29, to the read processing unit 30, to the drive unit 21, and the positioning unit 25. The control unit 20 comprises control circuitry, for example a microprocessor, a program memory, and control gates for performing the writing and/or reading functions. The control unit 20 may also be implemented as a state machine in logic circuits.

In an embodiment, the recording device is a storage system only, e.g. an optical disc drive for use in a computer. The control unit 20 is arranged to communicate with a processing unit in the host computer system via a standardized interface. Digital data is directly interfaced to the formatter 28 and the read processing unit 30.

In an embodiment, the device is arranged as a stand alone unit, for example a video recording apparatus for consumer use. The control unit 20, or an additional host control unit included in the device, is arranged to be controlled directly by the user and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are described, for example, for audio in WO 98/16014-A1 (PHN 16452) and for video in the MPEG2 standard. The input unit 27 processes the audio and/or video data into units of information which are passed on to the formatter 28. The read processing unit 30 may comprise suitable audio and/or video decoding units.

The formatter 28 is designed for adding control data and formatting and encoding the data in accordance with the recording format, e.g. by adding error correction codes (ECC), interleaving, and channel coding. Furthermore, the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed onto the laser power unit 29.

The laser power unit 29 receives the formatted data indicating the marks to be written and generates a laser power control signal which drives the radiation source in the optical head. The laser power is controlled in accordance with a power pattern that takes into account the preheating as described below.

Preheating is a known problem in the recording of write-once optical media (e.g. CD-R, DVD+R). Write-once optical media like CD-R, DVD-R, and DVD+R are by far the most popular formats for storing large amounts of data. One of the advantages of dye-based write-once media is their high compatibility with existing ROM formats. The recording of the data is generally due to heat-induced changes in the dye layer. Key performance targets for the media are recording speed and data capacity. Efforts to increase both these parameters lead to more thermal interference during the recording process: i.e. owing to higher speed and/or higher density, the heat required to form a specific mark affects the adjacent marks because of the shorter cooling times and/or shorter distances, respectively. Recently, dual-stack write-once media have been proposed (DVD+R-DL). Modifications to the stacks to meet optical requirements (semi-transparent L0, highly reflective L1) and ease of fabrication (inverted L1) have resulted in stacks that may be even more sensitive to preheating.

FIG. 3 shows preheating caused by a preceding mark. A first example shows a first mark 31 followed by a space and a next mark 32. An amount of heat is generated during writing of the first mark 31. An arrow indicates a first preheat 33 transferred via a relatively short space to the beginning of the next mark 32. A second example shows a third mark 34 followed by a space and a fourth mark 36. Again the amount of heat is generated during writing of the third mark 34. An arrow indicates a second preheat 35 transferred via a relatively long space to the beginning of the fourth mark 36. Owing to the longer space, the second preheat 35 is less than the first preheat 33. Preheat is generally counteracted by either shifting the leading edge of the write pulse, or by adjusting the height of the first power level of the write pulse, depending on the length of the previous space, as described in WO 01/86643. This is based on the idea that shorter spaces give insufficient cooling of the stack: the position to be recorded has a somewhat raised temperature; applying a lower write-power level or delaying the write pulse can correct this preheat.

Experiments have shown that the amount of preheat not only depends on the previous space length (cooling) but also on the length of the previously recorded mark (heat accumulation).

FIG. 4 shows a graph of inter-symbol interference. A graph 41 shows the total space length distribution (gray) in comparison with the space length directly behind a 7T mark (black). A Table 42 shows the average values for spaces of the run lengths 3T to 11T of all spaces, the deviation percentage δ/T [%], and the number of samples N; and also the average values for selected spaces following the 7T mark Ave(sel), the deviation percentage δ/T [%] (sel), and the number of samples N(sel). The black parts show that the spaces behind the 7T are too short. A similar effect is found for long marks in general. The effect may also be described by all marks following the (too short) space being too long (not shown as such in the graph). The deviation of the nominal run lengths result in raised jitter levels. The main reason for this problem appears to be accumulation of heat in the recording of longer marks.

FIG. 5 shows the accumulation of heat and the resulting preheat. A first example shows a first mark 51 followed by a space and a next mark 52. An amount of heat is generated during writing of the first mark 51. An arrow indicates a first preheat 53 transferred via a space of a selected length to the beginning of the next mark 52. A second example shows a third mark 54 followed by a space and a fourth mark 55. Again the amount of heat is generated during writing the third mark 54. An arrow indicates a second preheat 56 transferred via a space of the same selected length to the beginning of the fourth mark 55. The shorter mark 54 before the space causes the second preheat 56 to be less than the first preheat 53. The solution to this problem is to limit the heat for recording of the final part of the longer marks as much as possible.

FIG. 6 shows write power patterns having a reduced bias power in longer marks. A first power pattern 61 for a short mark has a first pulse 62 followed by further pulses 63, which pulses are separated by intermediate periods 64 so as to constitute a multi-pulse power pattern. The pulses have an intensity of a write power 65, and the intermediate periods have a bias power 66. In between power patterns there is a cooling power 67 which is very low (or zero). Above a certain length of the mark to be recorded, the bias level in between multi-pulses is reduced. A second power pattern 68 for a long mark has its first pulse 62 followed by further pulses separated by intermediate periods. During the longer power pattern the further intermediate periods 69 have a reduced bias power 70 for some of the time. This reduction of the bias power-level in the longer marks means that less heat is accumulated during the recording. It is noted that the power pattern for the longer mark comprises more than three pulses having the write power, two intermediate periods between the pulses having the nominal bias power, and two intermediate periods between the pulses having the reduced bias power. The intermediate periods having the reduced bias power include the intermediate period before the final pulse of the power pattern.

A different solution may be to shorten the multi-pulse duty cycle (i.e. shorter pulse and longer intermediate period) or to reduce the height (i.e. a reduced write power after a certain time) of the multi-pulse. It is noted that these solutions may be to the detriment of modulation (less broad recording of the longer marks).

In a practical embodiment of the device, the long run length using the power pattern with a reduced bias power level is about twice the minimum run length. For example, if the minimum run length is three run lengths (3T) long, the long run length is seven run lengths units (7T) long, as shown in the example of FIG. 7.

In an embodiment of the device, the reduced bias power is gradually reduced in dependence on the run length. For example, the bias power may start at the nominal bias power at the first intermediate period, and subsequent periods may have subsequently further reduced bias powers. Alternatively, the reduction of the bias power may be in a few steps, e.g. the reduced bias power having two reduced bias power levels.

In an embodiment of the device, the reduced bias power is applied from a predetermined moment with respect to the start or the end of the power pattern. For example, the bias power may be reduced a pre-selected number of clock cycles after the start of the power pattern, even if the change to reduced bias power takes place during an intermediate period.

In an embodiment of the device, a duty cycle of the pulses and intermediate periods is substantially 50%. The power pattern will usually be executed by means of a digital clock signal. Hence changes of the power level will occur at clock signal intervals. A duty cycle of 50%, 33%, 25%, etc. can be easily realized. Suitable values for the bias power are between 40% and 50% of the write power, while the reduced bias power is between 20% and 35% of the write power.

In an embodiment, the power pattern for a space includes a cooling period having a cooling power, in particular the cooling power being less than 1% of the write power.

FIG. 7 shows power patterns for a range of run lengths. The Figure gives the corresponding power pattern for each of the run lengths in the range 3T to 14T using the following notation. One row of 8 characters indicates one bit period T, wherein (w) indicates write power Pw, (b) indicates bias power, (r) indicates reduced bias power, and (c) indicates cooling power. The nominal bias level (b) is 0.45*Pw; reduced bias level (r) is 0.3*Pw. The duty cycle of pulses and intermediate periods is 50%. The reduced bias power is applied for lengths of 7T and longer. It is noted that the reduction of the bias power is activated at the start of bit 5 in the power patterns of run lengths 7 to 14, i.e. within the intermediate period. The example has been tested as a write strategy for L0 of DVD+R-DL (dual-layer disc).

FIG. 8 shows a graph of inter-symbol interference using the power patterns having reduced bias power. The Figure shows the total space length distribution similar to FIG. 4, but using the improved write strategy example given in FIG. 7. The inter-symbol interference (ISI) graph has improved considerably (cf. the ISI graph of FIG. 4 which uses a single bias level of 0.4*Pw). The improvement in this case is 1% less data-to-clock jitter.

In an embodiment, the record carrier comprises control information for setting the reduced bias power. An example of including control information in a wobbled pregroove is described in U.S. Pat. No. 5,060,219. The control parameters included in a preformed part of the track on the record carrier may indicate values for the write power and the bias power, and in particular the reduced bias power. In an embodiment, the control information may indicate the power patterns in detail, e.g. indicating the time at which the reduction of the bias power is to be applied, or the reduced bias power at different recording speeds.

Although the invention has been explained mainly with reference to embodiments using the DVD+R dual layer, it may be useful as well for high-speed R-recording (DVD+R) and high-density R-media (DVD+R, Blu-ray Disc BD-R). Also, an optical disc has been described as the information carrier, but other media such as an optical card or tape may be used. It is noted that the word ‘comprising’ in this document does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Furthermore, the scope of the invention is not limited to the embodiments, and the invention lies in each and every novel feature or combination of features described above.

1. Device for recording information in a track (11) on a record carrier (4), the device comprising:
a head (22) for generating a beam of radiation from a radiation source for writing marks and spaces between the marks, the marks and spaces each having a nominal run length of a predetermined number of bits, and the marks having a multitude of different run lengths for representing the information, the different run lengths being within a range of run lengths and the range including at least one short run length and at least one long run length that is longer than the short run length,
radiation source control means (29) for controlling the power of the radiation source during said writing in accordance with a power pattern in dependence on the run length, the power pattern for a mark of the long run length comprising
at least three pulses having a write power,
at least one first intermediate period between the pulses having a bias power, and
at least one second intermediate period between the pulses having a reduced bias power, the at least one second intermediate period including the intermediate period before the final pulse of the power pattern.

2. Device as claimed in claim 1, wherein the reduced bias power is gradually reduced in dependence on the run length, or the reduced bias power comprises at least two reduced bias power levels.

3. Device as claimed in claim 1, wherein the reduced bias power is applied from a predetermined moment with respect to the start or the end of the power pattern.

4. Device as claimed in claim 1, wherein the long run length is substantially twice the minimum run length in the range of run lengths.

5. Device as claimed in claim 2, wherein the minimum run length in the range of run lengths is three run lengths units (3T), and the long run length is seven run lengths units (7T).

6. Device as claimed in claim 1, wherein a duty cycle of the pulses and intermediate periods is substantially 50% and the bias power is between 40% and 50% of the write power, and the reduced bias power is between 20% and 35% of the write power, in particular the bias power being substantially 45% of the write power, and the reduced bias power being substantially 30% of the write power.

7. Device as claimed in claim 1, wherein the power pattern for a space comprises a cooling period having a cooling power, in particular the cooling power being less than 1% of the write power.

8. Method of controlling the power of a radiation source during recording information in a track on a record carrier, the method comprising:
writing of marks and spaces between the marks, the marks and spaces each having a nominal run length of a predetermined number of bits, and the marks having a multitude of different run lengths for representing the information, the different run lengths being within a range of run lengths and the range including at least one short run length and at least one long run length that is longer than the short run length,
controlling the power of the radiation source during said writing in accordance with a power pattern in dependence on the run length, the power pattern for a mark of the long run length comprising
at least three pulses having a write power,
at least one first intermediate period between the pulses having a bias power, and
at least one second intermediate period between the pulses having a reduced bias power, the at least one second intermediate period including the intermediate period before the final pulse of the power pattern.

9. Record carrier of a recordable type comprising a track for recording information, the recording comprising
writing of marks and spaces between the marks, the marks and spaces each having a nominal run length of a predetermined number of bits, and the marks having a multitude of different run lengths for representing the information, the different run lengths being within a range of run lengths and the range including at least one short run length and at least one long run length that is longer than the short run length,
controlling the power of the radiation source during said writing in accordance with a power pattern in dependence on the run length, the power pattern for a mark of the long run length comprising
at least three pulses having a write power,
at least one first intermediate period between the pulses having a bias power, and
at least one second intermediate period between the pulses having a reduced bias power, the at least one second intermediate period including the intermediate period before the final pulse of the power pattern,
the record carrier comprising control information for setting the reduced bias power.
